(19) United States
(12) Patent Application Publication
(10) Pub. No.: US 2017/0057883 A1
(43) Pub. Date: Mar. 2, 2017

(54) Combustible Triazine Combinations

(71) Applicant: THE UNITED STATES GOVERNMENT AS REPRESENTED BY THE SECRETARY OF THE ARMY-U.S. ARMY RESEARCH LABORATO, Adelphi, MD (US)

(72) Inventors: WILLIAM MATTHEW SHERRILL, ABERDEEN, MD (US); JOSEPH ERIK BANNING, NORTH EAST, MD (US); ERIC JAMES BUKOWSKI, CHURCHVILLE, MD (US)

(73) Assignee: THE UNITED STATES GOVERNMENT AS REPRESENTED BY THE SECRETARY OF THE ARMY, WASHINGTON, DC (US)

(21) Appl. No.: 14/838,396

(22) Filed: Aug. 28, 2015

(51) Int. Cl. C06B 25/34; F02K 9/72; F42B 12/20

(52) U.S. Cl. CPC C06B 25/34; F42B 12/207; F02K 9/72

(57) ABSTRACT

Provided herein is a symmetric amino triazine for use as a fuel and ignition source in chemically initiated illuminates or igniters. 3-amino-1,2,4-triazine act as a fuel and generates enough heat on exposure to as little as one drop of one hundred percent nitric acid to spontaneously ignite.

### GOVERNMENTAL INTEREST

The invention described herein may be manufactured, used and licensed by or for the United States Government.

### FIELD OF USE

The present application relates generally to amino triazine compound in combustible or illuminant combinations, as well as rocket propellants.

One amino triazine compound, namely 3-amino-1,2,4-triazine (MW 96.09), was described in the 1950 in a patent to Erickson. Since its synthesis, this compound has been investigated as a precursor to a variety of materials and pharmaceutical agents, but has never been applied as a fuel and ignition source in pyrotechnic formulations. It has now been discovered that while the compound is stable in admixture with numerous oxidants, it is highly combustible when mixed with nitric acid.

### SUMMARY

Provided among other things is a combustive combination comprising a compound of Formula I:

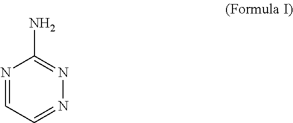

and nitric acid (HNO₃), hydroxylamine nitrate, or a combination thereof, wherein nitric acid is maintained apart from the compound of Formula I to the extent necessary to prevent combustion. Further provided is a shell (large caliber muntion), for example a tank, artillery or other weapon, or hybrid rocket motor comprising the combustive combination, wherein the compound of Formula I comprised solid propellant and nitric acid is configured as a liquid oxidizer for combusting the solid propellant. Also provided is a liquid fueled rocket motor comprising the combustive combination, wherein a mixture comprising compound of Formula I and hydroxylamine nitrate comprise the liquid fuel.

Also provided is a pyrotechnic illuminate composition comprising: a compound of Formula I; an oxidizer; and an illuminant. Further provided is method of propelling an object comprising combusting a compound of Formula I and a method of providing a pyrotechnic display by combining and (concurrently or thereafter) igniting the compound of Formula 1; an oxidizer; and an illuminant.

### DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope, for the invention may admit to other equally effective embodiments.

FIG. 1 depicts an exemplary hybrid rocket motor;

FIG. 2 shows an exemplary liquid rocket.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

The 3-amino-1,2,4-trizaine (aka, amino as-triazine) compound used in the invention can be made for example according to the following scheme:

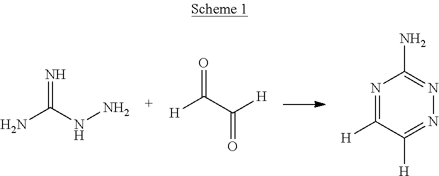

Reaction conditions can be as outlined in Erickson, U.S. Pat. No. 2,653,933 and Radel et al., J. Org. Chem. 1977; 42:546-550. As alluded to there, the amino guanidine compound can be reacted as the bicarbonate salt, with the reaction evolving carbon dioxide.

When as little as one drop of 100% HNO₃ is added to 3-amino-1,2,4-triazine, at ambient conditions, the mixture rapidly begins to generate heat and bursts into flames. Using a standard video camera shooting at 24 frames per second, the time from the first contact of the HNO₃ to the first emission of light is approximately 300 ms. Thus, the compound of Formula I, largely found to be stable against combustion, are combustible with this oxidant.

In certain embodiments of the combustive combination, the oxidant is kept separate from the 3-amino-1,2,4-triazine. Current experimentation has found no level of HNO₃ that can be contacted with 3-amino-1,2,4-triazine without combustion. If there is a level, and/or conditions where there can be some non-explosive contact, and where the combination can be combusted, these can be determined by ordinary experimentation. For all combinations that are contemplated, ordinary experimentation with hazardous materials will dictate standard and ordinary testing to confirm conditions for safe handling.

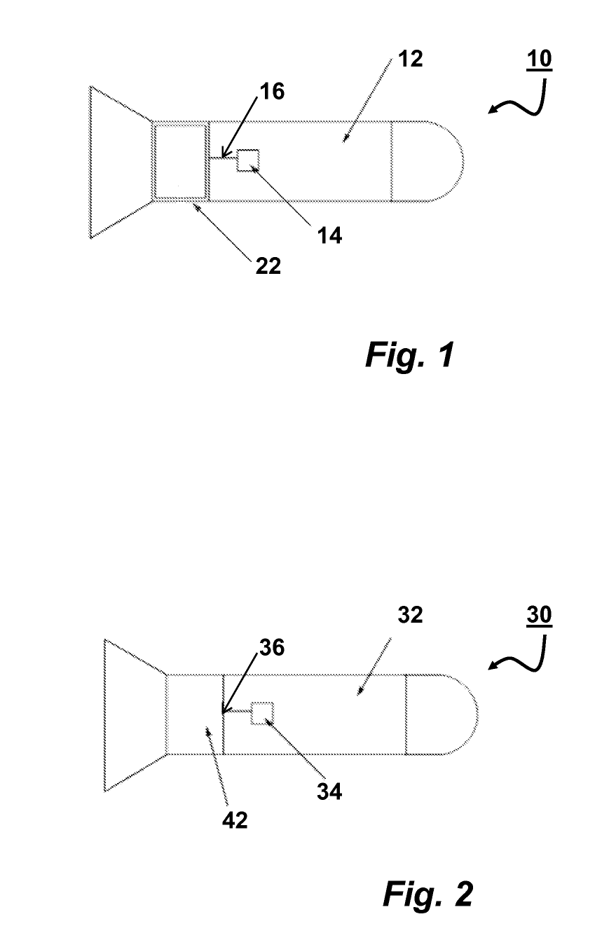

FIG. 1 shows an illustrative hybrid rocket propulsion system 10. Included are a liquid fuel tank 12 (containing for example nitric acid), pump 14, conduit 16 and combustion chamber 22, in which is situated propellant grain such as compound of Formula I. The pump provides an illustrative method of injecting the liquid fuel onto the propellant grain to combust it.

The 3-amino-1,2,4-triazine is resistant to thermal initiation of combustion as measured by differential scanning calorimetry. Resistance to thermal initiation is such that the material chars to exposure to open flame (at least 500° C. flame).

The 3-amino-1,2,4-triazine is resistant to combustion initiation from friction as measured by BAM friction tester conducted according to Milstd (MIL-STD-1751A. Safety and Performance Tests for the Qualification of Explosives (High Explosives, Propellants, and Pyrotechnics) 2001).

The 3-amino-1,2,4-triazine is resistant to combustion initiation from impact as measured by the small scale impact test as outlined in by Langlie in his one shot test method. (Langlie, H. J. A Reliability Test for “One-Shot” Items. Technical Report U-1792 Aeronutronic Division of Ford Motor Company, Newport Beach, Calif., USA, 1965).

The 3-amino-1,2,4-triazine is resistant to combustion initiation from electrostatic shock as measured by an ABL laboratories electrostatic discharge apparatus test conducted according to Milstd.

The predicted performance characteristics of the 3-amino-1,2,4-triazine combustion system were obtained through first using quantum mechanical modeling to determine the heat of formation and density. From this data, it is possible to use the Cheetah 7.0 thermochemical code (from Lawrence Livermore National Laboratory) to obtain calculated performance values. (See Bastea et al., Cheetah 7.0 User's Manual, LLNL-SM-599073, Lawrence Livermore National Laboratory, Livermore, Calif., 2012.) The heat of formation (ΔH_{f}) and density estimates were obtained using the methods detailed by Rice and Byrd. (See Byrd and Rice, Improved Prediction of Heats of Formation of Energetic Materials Using Quantum Mechanical Calculations. J. Phys. Chem. A 2006, 110, 1005-1013; Rice et al., Predicting Heats of Formation of Energetic Materials Using Quantum Mechanical Calculations. Combust. Flame 1999, 118, 445-458; Rice et al., Accurate Predictions of Crystal Densities Using Quantum Mechanical Molecular Volumes. J. Phys. Chem A 2007, 111, 10874; Byrd and Rice, Comparison of Methods to Predict Solid Phase Heats of Formation of Molecular Energetic Salts. J. Phys. Chem. A 2009, 113, 345; Rice and Byrd, Evaluation of Electrostatic Descriptors for Predicting Crystalline Density. J. Comput. Chem 2013, 34, 2146-2151.) Using their methodology, 3-amino-1,2,4-triazine is predicted to have a density of 1.439 g/cm³ and a ΔH_{f} of 53.851 kilocalorie per mole (kcal/mol). The calculated density is in good agreement with an experimentally determined 1.473 g/cm³ measured through xray diffraction by Perpetuo et al. in 2002 (J. Acta Cryst. 2002, 58, 431-432).

Using Cheetah, a formulation of 100% nitric acid (HNO₃) and 3-amino-1,2,4-triazine were optimized to generate high ISP of from about 250 and greater. Using the formulation optimization tool, Cheetah predicts the formulation can be 33.82% of 1 and 66.18% HNO₃ by weight. This formulation is predicted to generate a specific impulse (ISP) of 259.82 seconds. In embodiments, the weight ratio of nitric acid to compound of formula I is from about 55:45 HNO₃ to amino-1,2,4-triazine to about 80:20, with a useful formulation consisting of about 67% HNO₃ and about 33% 3-amino-1,2,4-triazine. In embodiments, the combustive combination or pyrotechnic illuminate composition has an ISP of about 250 seconds or more.

Additionally, it has been discovered that dissolving 3-amino-1,2,4-triazine into a solution of hydroxylamine nitrate (HAN) in a 1:3 fuel to oxidizer ratio (weight) results in a mixture with a predicted impulse of approximately 250 seconds. Slight heating was dissolves all of the 3-amino-1,2,4-triazine to dissolve in the HAN solution. Under ambient conditions, no reaction occurred. No bubbles or other signs of decomposition were observed once the dissolution of 1 into the HAN solution was complete. When the mixture is slowly heated in a test tube to approximately 300° C., after all of the water has boiled out of the mixture, there is a large volume of NO₂ gas that is liberated. This is accompanied with charring of the residual sample. However, when the solution is dropped on a plate which has been pre-heated to 300° C. or above, large flames appear from the mixture and very little residue is left on the plate after the event has completed. Both a solution of HAN and solid 3-amino-1,2,4-triazine were separately dropped onto the same pre-heated plated, and neither sample exhibited the same decomposition behavior as was seen with the solution of HAN and 3-amino-1,2,4-triazine.

The weight ratio for a useful formulation is 80% HAN to 20% 1; however, other ratios have been used, such as 67% HAN and 33% 1, and these also exhibited the same combustion behavior when dropped onto the heated plate. In embodiments, the weight ratio of HAN to 1 is from about 60:40, to about 90:10.

Accordingly, the 3-amino-1,2,4-triazine in mixture with HAN is suitable for use in a liquid-fueled propulsion system, for example using a heated combustion chamber. The HAN and 3-amino-1,2,4-triazine can be provided pre-mixed in appropriate ratios or be provided from separate chambers and mixed as or immediately prior to when the components come into the reaction chamber.

In FIG. 2, an illustrative liquid rocket propulsion system 30 is shown. Included are a liquid fuel tank 32 (containing for example HAN pre-mixed with compound of Formula I), pump 34, conduit 36 and combustion chamber 42, which can be pre-heated such that fuel ignites on injection therein.

The mixture of 3-amino-1,2,4-triazine with HAN is resistant to combustion initiation from friction or impact.

As described below, pyrotechnic combustion mixtures can be made with LiClO₄ as oxidant, and boron as illuminant. The oxidizer can comprise for example KClO₃, KNO₃, a perchlorate salt (including without limitation Mg and Sr salt), or a mixture thereof. The oxidizer can comprise for example NH₃ClO₄, KClO₃, KClO₄, LiClO₄, KNO₃, or a mixture thereof. The illuminant can comprise for example a metal or metal salt illuminant. The illuminant can comprise for example Cu, Mg, Sr, B, Ni, or a mixture thereof.

In embodiments, the pyrotechnic compositions containing compound of Formula I are resistant to combustion initiation from friction, impact, electrostatic shock or heat.

FIG. 1 shows an illustrative hybrid rocket propulsion system 10. Included are a liquid fuel tank 12 (containing for example nitric acid), pump 14, conduit 16 and combustion chamber 22, in which is situated propellant grain such as compound of Formula I.

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

Specific embodiments according to the methods of the present invention will now be described in the following examples. The examples are illustrative only, and are not intended to limit the remainder of the disclosure in any way.

Where a sentence states that its subject is found in embodiments, or in certain embodiments, or in the like, it is applicable to any embodiment in which the subject matter can be logically applied.

### EXAMPLE I

### Preparation of 3-Amino-1,2,4-triazine

3-Amino-1,2,4-triazine was prepared by a slight modification to the process described in: Erickson, J. G. Aminoheterocycles. U.S. Pat. No. 2,653,933. American Cyanamid Company, New York, N.Y. Sep. 29, 1953.

NMR spectra were recorded on an Anasazi Instruments 90 MHz NMR with DMSO-d₆ as the solvent. All NMR chemical shifts are reported in ppm relative to TMS-Cl. FTIR spectra were recorded using a Bruker Alpha-T fitted with a diamond ATR (DATR) cell. Density was measured using gas pycnometry on a Micromeritics AccuPyc 1330 using helium as the analysis gas. Differential scanning calorimetry (DSC) was performed on a TA instruments Q10 or Q20 calorimeter calibrated to the melting point of indium. H50 values for drop weight testing were determined using the Langlie one-shot method on a tester dropping a 5 lb weight from a maximum height of 60 in. Friction sensitivity measurements were determined on a BAM friction tester and ESD was determined using an ABL ESD apparatus. All deuterated solvents were obtained from Cambridge Isotope Laboratories, Andover, Mass., USA. All other materials used were obtained from Sigma Aldrich Corp. St. Louis, Mo., USA and were used as received unless otherwise noted.

Amino guanidine bicarbonate (29.2 g, 215 mmol) was suspended in 60 mL of water. To this was added 22.8 g (157 mmol) of 40% aqueous glyoxal and the mixture was allowed to stir for 18 hours at 20-25° C. The suspended solid was then filtered, and the mother liquor was evaporated to dryness. The resulting residue was extracted with ice cold methanol (3×50 mL) and the combined methanol rinses were then re-cooled, filtered, and the mother liquor was concentrated. The resulting solid was recrystallized from acetonitrile to yield 11.23 g (117 mmol, 75%) of a slightly yellow solid, 3-amino-1,2,4-triazine.

DSC 10° C./min melt at 177° C. was in good agreement with literature values. NMR data were in agreement with what has been previous published in the literature. ¹H NMR DMSO-d₆ (90.420 MHz) δ 8.52 {d, J=2.4 Hz, 1 H), 8.19 (d, J=2.4 Hz, 1H), 7.16 (br. s. 2H); ¹³C NMR DMSO-d₆ (22.605 MHz) δ 163.4, 150.0, 140.7; FTIR (DATR), ñ=3292, 3098, 1557, 1532, 1516, 1489, 1113, 1076, 1044, 865, 848, 794, 633, 593, 460; MS (EI)=42, 68, 96 (M+).

### EXAMPLE II

### Preparation of HAN

Using a volumetric pipette, 1 mL of a commercially available 50% by weight solution of hydroxylamine was added to a test tube and cooled to 0° C. in an ice bath. To this was slowly added 953 mg of 100% HNO3 and the mixture was stirred for 5 minutes then allowed to warm to ambient temperature. This resulted in a solution that was 74% HAN by weight.

### EXAMPLE III

### Preparation of HAN Mixture with 3-Amino-1,2,4-triazine

340 mg of 3-amino-1,2,4-triazine were dissolved with slight heating into the 1 ml HAN solution.

### EXAMPLE 4

### Chemically Initiated Pyrotechnic

A mixture containing 75% 3-amino-1,2,4-triazine, 15% elemental amorphous boron, and the balance LiClO₄ by weight, was added to a ball mill, and milled until the mixture appeared as a dark grey powder. Addition of 100% HNO₃ resulted in the spontaneous ignition of the system and the emission of green tinted light.

This invention described herein is of combustible formulation and methods of forming and using the same. Although some embodiments have been discussed above, other implementations and applications are also within the scope of the following claims. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

What is claimed is:

1. A combustive combination comprising compound of Formula I: 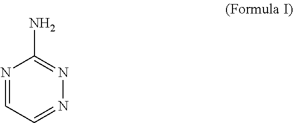
and nitric acid (HNO₃), hydroxylamine nitrate, or a combination thereof,
wherein nitric acid is maintained apart from the compound of Formula I to the extent necessary to prevent combustion.

2. A shell or hybrid rocket motor comprising the combustive combination of claim 1, the shell or hybrid rocket motor comprising:
a combustion chamber wherein solid propellant comprising the compound of Formula is situated to provide propulsion when ignited; and
a liquid fuel tank configured to inject liquid oxidizer comprising nitric acid onto the solid propellant to ignite it.

3. A liquid fueled rocket motor comprising the combustive combination of claim 1, wherein a mixture comprising compound of Formula I and hydroxylamine nitrate comprise liquid fuel.

4. A combustible combination of claim 1, wherein the compound of Formula I is in mixture with a solution of hydroxylamine nitrate.

5. The combustible combination of claim 4, wherein the mixture is resistant to combustion initiation from friction or impact.

6. A pyrotechnic illuminate composition comprising:
compound of Formula I: 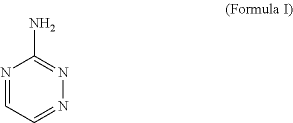
; an oxidizer; and
an illuminant.

7. The pyrotechnic illuminate composition of claim 6, wherein the oxidizer comprises KClO₃, KNO₃, a perchlorate salt, or a mixture thereof.

8. The pyrotechnic illuminate composition of claim 6, wherein the oxidizer comprises NH₃ClO₄, KClO₃, KClO₄, LiClO₄, KNO₃, or a mixture thereof.

9. The pyrotechnic illuminate composition of claim 7, wherein the illuminant comprises a metal or metal salt illuminant.

10. The pyrotechnic illuminate composition of claim 7, wherein the illuminant comprises Cu, Mg, Sr, B, Ni, or a mixture thereof.

11. The pyrotechnic illuminate composition of claim 6, wherein the illuminant comprises a metal or metal salt illuminant.

12. The pyrotechnic illuminate composition of claim 6, wherein the illuminant comprises Cu, Mg, Sr, B, Ni, or a mixture thereof.

13. The pyrotechnic illuminate composition of claim 6, wherein the composition is resistant to combustion initiation from friction, impact, electrostatic shock or heat.

14. A method of propelling an object comprising combusting compound of Formula I:

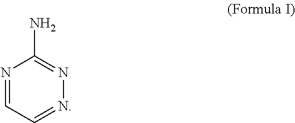

15. The method of claim 14, wherein the combusting comprises reacting the compound of Formula I with nitric acid (HNO₃), hydroxylamine nitrate, or a combination thereof.
